(19) United States
(12) Patent Application Publication
(10) Pub. No.: US 2024/0049704 A1
(43) Pub. Date: Feb. 15, 2024

(54) Emulsion

(71) Applicant: Animal Health Concepts B.V., Heino (NL)

(72) Inventor: Andreas Petrus Jozef Schrijver, Heino (NL)

(21) Appl. No.: 18/552,171

(22) PCT Filed: Mar. 23, 2022
(86) PCT No.: PCT/EP2022/057563

§ 371 Date: Sep. 23, 2023

(30) Foreign Application Priority Data
Mar. 23, 2021 (EP) 21164410.9

(51) Int. Cl. A01N 25/04; A01P 7/04; A01P 13/00; A01P 3/00; A23K 20/158; A23K 20/163; A23D 7/005

(52) U.S. Cl. CPC A01N 25/04; A01P 7/04; A01P 13/00; A01P 3/00; A23K 20/158; A23K 20/163; A23D 7/0053

(57) ABSTRACT

The invention pertains to an oil-in-water emulsion comprising: an oil comprising an active ingredient, and optionally a solvent for dissolving the active ingredient; water; and an emulsifier comprising acacia gum and a polysaccharide thickener to form oil droplets of the oil, wherein the d50 value of the oil droplets is at most 2 μm.

The present invention relates to oil-in-water emulsions.

Oil-in-water emulsions are well known in the art. The oil droplets are generally stabilized using a conventional emulsifier. The oil in such emulsions are generally not miscible with water or solidify/crystalize in excess water. One of the challenges of such emulsions is its stability over time; the particle size generally increases considerably which may even lead to phase separation. In addition, some applications require strong dilution in water before application, e.g. in feed or agrochemical uses. The oil droplets should be stabilized such that the emulsion stays intact after dilution, and the oil droplets can be uniformly distributed across the final medium. There is a need for emulsifier systems capable of providing such stability.

The objective of the present invention is to provide novel oil-in-water emulsions.

The present invention pertains to an oil-in-water emulsion comprising: an oil comprising an active ingredient, and optionally a solvent for dissolving the active ingredient; water; and an emulsifier comprising acacia gum and a polysaccharide thickener to form oil droplets of the oil, wherein the d50 value of the oil droplets is at most 2 μm. The combination of acacia gum and the polysaccharide thickener as emulsifier brings about oil-in-water emulsions with small oil droplet sizes, even submicron oil droplet sizes, which are stable upon storage and upon considerable dilution. Storage stability of the inventive emulsions of over 12 months have been observed. 100-fold or even 1000-fold dilutions with water generally do not alter the oil droplet size considerably, which is particularly advantageous in animal feed and agrochemical applications. It was further found that the polysaccharide thickener, in particular xanthan gum, serves as an emulsifier in combination with acacia gum, whereas the thickener, such as xanthan gum, is generally known for its rheology modification/increasing properties. The emulsions of the invention generally have a low viscosity (almost water thin), are well pourable and easy to dilute or mix into feed, feed premix or water. Without being bound by theory, the polysaccharide combines with the acacia gum as an emulsifier on the oil/water interface, and consequently does not to its full extent contribute to the viscosity increase that is normally observed when the polysaccharide is added to pure water in the same amount as used in the emulsion. The inventive emulsions further reduce or even diminish the evaporation of volatile compounds, therewith improving the safety and stability of the emulsions.

The d50 value of the oil droplets is at most 2 μm, preferably at most 1.5 μm, more preferably at most 1.2 μm, even more preferably at most 1.0 μm and most preferably at most 0.8 μm, and generally at least 50 nm, preferably at least 75 nm, more preferably at least 100 nm and most preferably at least 125 nm. The d50 value is a measure for the particle size distribution of particles and/or droplets, which can be determined using conventional techniques such as laser diffraction.

Alternatively or additionally, the oil droplets have a d90 value of at most 2 μm, preferably at most 1.5 μm, more preferably at most 1.2 μm, even more preferably at most 1.0 μm and most preferably at most 0.8 μm, and generally at least 50 nm, preferably at least 75 nm, more preferably at least 100 nm and most preferably at least 125 nm. The d90 value is a measure for the particle size distribution of particles and/or droplets, which can be determined using conventional techniques such as laser diffraction.

In a further embodiment, the emulsion comprises oil droplets with a monomodal distribution. In the context of this application the term “monomodal distribution” refers to a particle size distribution exhibiting one peak in the particle size distribution graph obtained using conventional light scattering techniques. In contrast, the particle size distribution can be bimodal or polymodal which means that two or more peaks are observed.

The oil suitable in the emulsion of the invention is any oil or hydrophobic liquid known in the art. The oil may be a solvent for the active ingredient, or may predominantly or exclusively comprise the active ingredient per se. In case active ingredient is predominantly present (i.e. at least 50 wt %, based on the total weight of the oil), a solvent and/or other additives are present. Examples of oils that serve as a solvent to the active ingredient include hydrocarbon oils such as mineral oil fractions comprising linear mineral oils (n-paraffins), branched mineral oils (iso-paraffinic) and/or cyclic mineral oils (naphthenic oils); polyisobutylenes (PIB), phosphate esters such as trioctyl phosphate; polyalkylbenzens such as heavy alkylates, dodecyl benzene and other alkylarenes; esters of aliphatic monocarboxylic acids; linear or branched mono unsaturated hydrocarbons such as linear or branched alkanes containing 8 to 25 carbon atoms and linear or branched alkenes containing 8 to 25 carbon atoms; and natural oils such as palm oil, soybean oil, olive oil, sunflower oil, rapeseed oil, castor oil and processed oils thereof.

The active ingredient may be any active ingredient known in the art. The active ingredient refers to compounds or composition which exhibit an activity in humans, plants and/or animals. Such active ingredients include feed additive ingredients, feed ingredients, nutrients, agrochemical active ingredient, cosmetic active ingredient, veterinary active ingredient, pharmaceutically active ingredients and food ingredients. It is contemplated that two or more active ingredients can be used in the oil-in-water emulsion of the invention. In such case, the active ingredient can be from the same group of active ingredients, for example two different feed additive ingredients or two different agrochemical active ingredients, or from two or more different groups, e.g. the combination of a feed additive ingredient and a feed ingredient, or a food ingredient and a pharmaceutically active ingredient. In one embodiment, the active ingredient is selected from food additive ingredients and agrochemical active ingredients. In one embodiment, the active ingredient has a solubility in water at 25° C. of at most 10 g/l, more preferably at most 1 g/l and most preferably at most 0.1 g/l.

The feed additive ingredient may be any feed additive ingredient known in the art, which is generally lowly soluble in water. Preferably, the feed additive ingredient has a solubility in water at 25° C. of at most 10 g/l, more preferably at most 1 g/l and most preferably at most 0.1 g/l.

Examples of feed additive ingredients include natural oils or nature-identical components including essential oils such as cinnamaldehyde, menthol, thymol, linalool, limonene, capsaicin, eucalyptol, geraniol and eugenol; vegetable oils such as eucalyptus oil, thyme oil, jasmine oil, geranium oil, lemon grass oil, oregano oil and peppermint oil; beneficial bacteria such as Bacillus spp like Bacillus subitilis, Bacillus licheniformis, Bacillus amyloliquefaciens, Bacillus pumilis, Enterococcus spp, Pediococcus spp, Lactobacillus spp, Lactococcus spp and Bifidobacterium spp; and medium and long chain fatty acids such as capric acid, caprylic acid, lauric acid, stearic acid, linoleic acid and oleic acid. It is contemplated to use two or more feed additive ingredients in the emulsion of the invention. In one embodiment, a combination of two or more feed additive ingredients is used of which at least one has a solubility in water at 25° C. of at most 10 g/l, preferably at most 1 g/l and most preferably at most 0.1 g/l, while at least one has a solubility in water at 25° C. above 10 g/l. For feed additive ingredients, ingredients having a solubility exceeding 10 g/l at 25° C. include short chain fatty acids like acetic acid, formic acid, butyric acid, citric acid, propionic acid and caproic acid.

The agrochemical active ingredient may be any agrochemical active ingredient known in the art. Preferably, the agrochemical active ingredient has a solubility in water at 25° C. of at most 10 g/l, more preferably at most 1 g/l and most preferably at most 0.1 g/l. The agrochemical active ingredient may be an insecticide, a fungicide, a nematicide, a herbicide and/or a herbicide safener. Combinations of two or more agrochemical active ingredients are also contemplated. Also combinations of two different classes of active ingredients, such as an insecticide and a fungicide for example, are envisaged.

Examples of suitable insecticides include neonicotinoids such as imidacloprid, clotianidin, thiamethoxam, acetamiprid, dinotefuran, nitempyram and thiacloprid; carbamates such as thiodicarb, aldicarb, carbofuran, furadan, fenoxycarb, carbaryl, sevin ethienocarb and fenobucarb; diamides such as chlorantraniliprole, cyantraniliprole and flubendiamide; spinosyns such as spinosad and spinetoram; pyrethroids such as lambda-cyhalothrin, gamma-cyhalothrin and tefluthrin; and phenylpyrazole.

Examples of suitable fungicides include azoxystrobin, trifloxystrobin, fluoxastrobin, cyproconazole, difenoconazole, prothioconazole, tebuconazole, triticonazole, fludioxonil, thiabendazole, ipconazole, cyprodinil, myclobutanil, metalaxyl, metalaxyl-M (mefenoxam), amisulbrom, ametoctradin, boscalid, fluopyram, ilsotianil, penflufen, penthiopyrad, proquianazid, sedaxane and penflufen.

Examples of suitable nematicides include avermectins such as abamectin; carbamate nematicides such as aldicarb, thiodicarb, carbofuran, carbosulfan, oxamyl, aldoxycarb, ethoprop, methomyl, benomyl, alanycarb and iprodione; organophosphorus nematicides such as phenamiphos, fensulfothion, terbufos, fosthiazate, dimethoate, phosphocarb, dichlofenthion, isamidofos, fosthietan, isazofos ethoprophos, cadusafos, chlorpyrifos, heterophos, mecarphon, phorate, thionazin, triazophos, diamidafos, phosphamidon and imicyafos; and certain fungicides such as captan, thiophanate-methyl and thiabendazole.

Examples of suitable herbicides include 2,3,6-TBA, 2,4-D, 2,4-D-2-ethylhexyl, 2,4-D-butoyl, 2,4-D-isopropyl, acetochlor, aclonifen, alachlor, allidochlo, ametryn, amidosulfuron, aminopyralid, anilofos, atraton, atrazine, aziprotryne, barban, beflubutamid, benazolin-ethyl, benfluralin, benfuresate, benzoifenap, bifenox, bromacil, bromobutide, bromuron, butachlor, butamnifos, butenachlor, butralin, buturon, butylate, carfentrazone-ethyl, chlomethoxyfen, chlorbromuron, chlorphthalim, chlorpropham, chlorthal-dimethyl, chlorthiamid, cinmethylin, clethodim, clodinafop, clomazone, clopyralid, cycloate, cyclosulfamuron, cycloxydim, cyhalofip-butyl, dapalon, SYN545197, SYN545907, dazomet, defenuron, desmetryne, di-allate, dicamba, dichlobenil, dichlorprop-p, diclofop-methyl, diethatyl-ethyl, dimefuron, dimepiperate, diemthachlor, dimethametryne, dimethenamid, dimethenamid-p, dimethipin, dimexano, dinitramine, dinoseb, dinoterb, dipropetryn, dithiopyr, DNOC, EPTC, esprocarb, ethalfluralin, ethofumesate, ethoxysulfuron, fenoxaprop, fenoxaprop-p, fenuron, flamprop-m-isopropyl, flamprop-m-methyl, foramsulfuron, florasulam, fluazifop-p-butyl, fluazolate, flucarbazone, fluchloralin, flufenacet, flumetsulam, flumioxazin, flumipropyn, fluometuron, flupoxam, fluridone, flurochloridone, fluoroxpyr, fluthiazet, fosamine ammonium, haloxyfop-p-methyl, hexazinone, iodosulfuron, isopropalin, isouron, isoxaflutole, lactofen, linuron, MCPA, MCPA-2-ethylhexyl, MCPA-thioethyl, MCPB, MCPB-ethyl, mecoprop, mecoprop-p, mesotrione, mesosulfuron, metamifop, metazachlor, methabenzthiazuron, methazole, metobromuron, metalochlor, metoxuron, metribuzin, metsulfuron, molinate, monalide, monolinuron, monuron, napropamide, nicosulfuron, nitrofen, orbencarb, oxadiazon, oxyfluorfen, pebulate, pendimethalin, pethoxamid, piucloram, pinoxaden, piperophos, pretilachlor, primisulfuron, profluralin, profoxydim, prometon, prometryn, propachlor, propanil, propaquizafob, propisochlor, propoxycarbazone, propyzamide, prosulfocarb, prosulfuron, proximpham, pyrasulfotole, pyrazoxyfen, pyributicarb, pyriminobac-methyl, pyroxsulam, pyroxasulfone, quinoclamine, quinclorac, sulfufenacil, secbumeton, simethryn, s-metalochlor, sulcotrione, sulfallate, sulfosulfuron, tebutam, tebuthiuron, tembotrione, tepraloxydim, terbacil, terbumeton, terbuthylazine, terbutryn, thenylchlor, thiazafluron, thiazopyr, thiencarbazone, thiobencarb, thifensulfuron, tiocarbazil, mm tralkoxydim, triasulfuron, tri-allate, triclopyr, tridiphane, trifluralin, tritosulfuron, vernolate, and ZA9244.

Examples of suitable herbicide safeners include AD67, BAS 145138, benoxacor, cloquintocet-mexyl, cyprosulfamide, dichlormid, fenchlorazole-ethyl, flurazole, fluxofenim, furilazole, MG 191, oxabetrinil, naphthalic anhydride, mefenpyr-methyl, mefenpyr-diethyl, isooxadifen, oxabenitril, fenclorim, mefenpyr, cyometrinil and N-(2-methoxybenzoyl)-4-(methylamino carbonyl) amino) benzene sulfonamide.

In one embodiment of an oil-in-water emulsion, the emulsion may comprise the oil in an amount of at most 50% by weight (wt %), based on the total weight of the emulsion. Preferably, the oil is present in an amount of at most 40 wt %, more preferably at most 35 wt %, even more preferably at most 30 wt % and most preferably at most 25 wt %, and preferably at least 1 wt %, more preferably at least 2 wt %, even more preferably at least 5 wt % and most preferably at least 10 wt %, based on the total weight of the emulsion.

In one embodiment of an oil-in-water emulsion, the emulsion may comprise the oil in an amount of at most 50% by weight (wt %), based on the total weight of the oil and water. Preferably, the oil is present in an amount of at most 40 wt %, more preferably at most 35 wt %, even more preferably at most 30 wt % and most preferably at most 25 wt %, and preferably at least 1 wt %, more preferably at least 2 wt %, even more preferably at least 5 wt % and most preferably at least 10 wt %, based on the total weight of the oil and water.

In one embodiment of an oil-in-water emulsion, the emulsion may comprise water in an amount of at least 25% by weight (wt %), based on the total weight of the emulsion. Preferably, water is present in an amount of at least 30 wt %, more preferably at least 35 wt %, even more preferably at least 40 wt % and most preferably at least 45 wt %, and preferably at most 99 wt %, more preferably at most 98 wt %, even more preferably at most 95 wt % and most preferably at most 90 wt %, based on the total weight of the emulsion.

In one embodiment of an oil-in-water emulsion, the emulsion may comprise water in an amount of at least 25% by weight (wt %), based on the total weight of the oil and water. Preferably, water is present in an amount of at least 30 wt %, more preferably at least 35 wt %, even more preferably at least 40 wt % and most preferably at least 45 wt %, and preferably at most 99 wt %, more preferably at most 98 wt %, even more preferably at most 95 wt % and most preferably at most 90 wt %, based on the total weight of the oil and water.

The emulsion of the invention further comprises an emulsifier comprising acacia gum and a polysaccharide thickener. The acacia gum can be any acacia gum known in the art and suitable for use in the emulsion of the invention. The emulsion of the invention may comprise the acacia gum in an amount of at most 30% by weight (wt %), based on the total weight of the emulsion. Preferably, the acacia gum is present in an amount of at most 25 wt %, more preferably at most 20 wt %, even more preferably at most 15 wt % and most preferably at most 10 wt %, and preferably at least 0.1 wt %, more preferably at least 0.5 wt %, even more preferably at least 1 wt % and most preferably at least 2 wt %, based on the total weight of the emulsion.

Alternatively, the emulsion of the invention may comprise the acacia gum in an amount of at most 30% by weight (wt %), based on the total weight of the oil and water. Preferably, the acacia gum is present in an amount of at most 25 wt %, more preferably at most 20 wt %, even more preferably at most 15 wt % and most preferably at most 10 wt %, and preferably at least 0.1 wt %, more preferably at least 0.5 wt %, even more preferably at least 1 wt % and most preferably at least 2 wt %, based on the total weight of the oil and water.

The polysaccharide thickener can be any polysaccharide thickener known in the art. Examples of such polysaccharide thickeners include natural gums such as xanthan gum, guar gum, alginates, pectin and carrageenan; starch and modified starch; and modified cellulose such as carboxymethyl cellulose, methyl cellulose and hydroxypropyl methyl cellulose. In one embodiment, the polysaccharide thickener is a natural gum. The polysaccharide thickener generally serves as an emulsifier in combination with acacia gum, which means that the viscosity of the emulsion of the invention is lower than the viscosity of water in which the polysaccharide thickener is dissolved in the same amount as used in the emulsion. Preferably, the polysaccharide is selected from xanthan gum and guar gum. Xanthan gum is most preferred.

The emulsion of the invention may comprise the polysaccharide thickener in an amount of at most 10% by weight (wt %), based on the total weight of the emulsion. Preferably, the polysaccharide thickener is present in an amount of at most 5 wt %, more preferably at most 2 wt %, even more preferably at most 1.5 wt % and most preferably at most 1 wt %, and preferably at least 0.01 wt %, more preferably at least 0.05 wt %, even more preferably at least 0.1 wt % and most preferably at least 0.2 wt %, based on the total weight of the emulsion.

Alternatively, the emulsion of the invention may comprise the polysaccharide thickener in an amount of at most 30% by weight (wt %), based on the total weight of the oil and water. Preferably, the polysaccharide thickener is present in an amount of at most 5 wt %, more preferably at most 2 wt %, even more preferably at most 1.5 wt % and most preferably at most 1 wt %, and preferably at least 0.01 wt %, more preferably at least 0.05 wt %, even more preferably at least 0.1 wt % and most preferably at least 0.2 wt %, based on the total weight of the oil and water.

In one embodiment, the polysaccharide is guar gum. The guar gum can be any guar gum known in the art and suitable for use in the emulsion of the invention. The emulsion of the invention may comprise the guar gum in an amount of at most 10% by weight (wt %), based on the total weight of the emulsion. Preferably, the guar gum is present in an amount of at most 5 wt %, more preferably at most 2 wt %, even more preferably at most 1.5 wt % and most preferably at most 1 wt %, and preferably at least 0.01 wt %, more preferably at least 0.05 wt %, even more preferably at least 0.1 wt % and most preferably at least 0.2 wt %, based on the total weight of the emulsion.

Alternatively, the emulsion of the invention may comprise the guar gum in an amount of at most 30% by weight (wt %), based on the total weight of the oil and water. Preferably, the guar gum is present in an amount of at most 5 wt %, more preferably at most 2 wt %, even more preferably at most 1.5 wt % and most preferably at most 1 wt %, and preferably at least 0.01 wt %, more preferably at least 0.05 wt %, even more preferably at least 0.1 wt % and most preferably at least 0.2 wt %, based on the total weight of the oil and water.

In one embodiment, the polysaccharide is xanthan gum. The xanthan gum can be any xanthan gum known in the art and suitable for use in the emulsion of the invention. The emulsion of the invention may comprise the xanthan gum in an amount of at most 10% by weight (wt %), based on the total weight of the emulsion. Preferably, the xanthan gum is present in an amount of at most 5 wt %, more preferably at most 2 wt %, even more preferably at most 1.5 wt % and most preferably at most 1 wt %, and preferably at least 0.01 wt %, more preferably at least 0.05 wt %, even more preferably at least 0.1 wt % and most preferably at least 0.2 wt %, based on the total weight of the emulsion.

Alternatively, the emulsion of the invention may comprise the xanthan gum in an amount of at most 30% by weight (wt %), based on the total weight of the oil and water. Preferably, the xanthan gum is present in an amount of at most 5 wt %, more preferably at most 2 wt %, even more preferably at most 1.5 wt % and most preferably at most 1 wt %, and preferably at least 0.01 wt %, more preferably at least 0.05 wt %, even more preferably at least 0.1 wt % and most preferably at least 0.2 wt %, based on the total weight of the oil and water.

In one embodiment of the invention, the emulsion comprises the acacia gum and the polysaccharide thickener in a weight ratio of at least 1, preferably at least 2, more preferably at least 3 and most preferably at least 5, and generally at most 100, preferably at most 50, more preferably at most 30 and most preferably at most 20.

In one embodiment of the invention, the emulsion comprises the acacia gum and guar gum in a weight ratio of at least 1, preferably at least 2, more preferably at least 3 and most preferably at least 5, and generally at most 100, preferably at most 50, more preferably at most 30 and most preferably at most 20.

In one embodiment of the invention, the emulsion comprises the acacia gum and xanthan gum in a weight ratio of at least 1, preferably at least 2, more preferably at least 3 and most preferably at least 5, and generally at most 100, preferably at most 50, more preferably at most 30 and most preferably at most 20.

The remaining part of the emulsion may be comprised of other components commonly used in oil-in-water emulsions. With the oil, water and the emulsifier the other components add up to 100 wt % of the total weight of the emulsion.

The emulsion of the invention may further comprise a second emulsifier. The second emulsifier can be any emulsifier known in the art and which can form a stable emulsion with the emulsifier of the invention. Examples of such emulsifiers include food emulsifiers such as lecithin, soy lecithin, sodium phophates, mono- and diglycerides, sodium stearoyl lactylate, diacetyl tartaric ester of monoglyceride (DATEM); anionic detergents such as alkylbenzene sulfonates, N-acylglycinates and N-acylglutamates; cationic detergents such as quaternary ammonium compounds, non-ionic detergents such as polyoxyethylene-based detergents such as polysorbates (e.g. Tween 80) and polyoxyethylene octyl phenyl ether (Triton X-100) and glucosides such as octylthioglucoside (OTG); zwitterionic detergents such as betaines, N-alkylamidobetaines and polyaminocsarboxylates; and emulsifiers used in pharmacy such as emulsifying wax, polysorbate 20 and ceteareth 20.

The second emulsifier can be chosen according to need and in amounts as desired. The emulsion of the invention may comprise the second emulsifier in an amount of at most 35% by weight (wt %), based on the total weight of the emulsion. Preferably, the second emulsifier is present in an amount of at most 30 wt %, more preferably at most 25 wt %, even more preferably at most 20 wt % and most preferably at most 15 wt %, and preferably at least 0.5 wt %, more preferably at least 1 wt %, even more preferably at least 2 wt % and most preferably at least 5 wt %, based on the total weight of the emulsion.

Alternatively, the emulsion of the invention may comprise the second emulsifier in an amount of at most 35% by weight (wt %), based on the total weight of the oil and water. Preferably, the second emulsifier is present in an amount of at most 30 wt %, more preferably at most 25 wt %, even more preferably at most 20 wt % and most preferably at most 15 wt %, and preferably at least 0.5 wt %, more preferably at least 1 wt %, even more preferably at least 2 wt % and most preferably at least 5 wt %, based on the total weight of the oil and water.

The emulsions may further comprise additives such as heat stabilizers, flame retardants, UV stabilizers, fungicides, biocides, perfumes, relaxers, colorants, fillers, pigments and dyes, thickeners, preservatives, anti-oxidants, freeze thaw stabilizers, moisturizers, pH controlling agents, water phase stabilizing agents, vitamins, sebum absorbants, active ingredients and antifoams. The additive may also be an active ingredient as indicated above except that the solubility is at least 10 g/l, and the active ingredient will dissolve in the water phase rather than in the oil phase.

The additive can be chosen according to need in amounts as desired. The emulsion of the invention may comprise the additive in an amount of at most 30% by weight (wt %), based on the total weight of the emulsion. Preferably, the additive is present in an amount of at most 25 wt %, more preferably at most 20 wt %, even more preferably at most 15 wt % and most preferably at most 12 wt %, and preferably at least 1 wt %, more preferably at least 2 wt %, even more preferably at least 5 wt % and most preferably at least 8 wt %, based on the total weight of the emulsion.

Alternatively, the emulsion of the invention may comprise the additive in an amount of at most 30% by weight (wt %), based on the total weight of the oil and water. Preferably, the additive is present in an amount of at most 25 wt %, more preferably at most 20 wt %, even more preferably at most 15 wt % and most preferably at most 12 wt %, and preferably at least 1 wt %, more preferably at least 2 wt %, even more preferably at least 5 wt % and most preferably at least 8 wt %, based on the total weight of the oil and water.

The oil-in-water emulsion of the invention can be prepared using conventional techniques for producing submicron size oil droplets. Such techniques include homogenization, ultrasonication and using high shear.

The invention further pertains to a feed composition comprising an oil-in-water emulsion comprising an oil comprising a feed additive ingredient; and optionally a solvent for dissolving the feed additive ingredient; water; and an emulsifier comprising acacia gum and the polysaccharide thickener, preferably xanthan gum, to form oil droplets of the oil, wherein the amount of the feed additive ingredient is from 0.001 to 1 wt %, based on the total weight of the feed composition, wherein the d50 value of the oil droplet comprising the feed additive ingredient is at most 2 μm, preferably 1 μm. The oil-in-water emulsion may have the same embodiments as described above. The feed composition may further comprise feed excipients that are generally used in feed compositions such as nutrients and minerals or excipients capable of improving the uptake of the feed additive ingredient or delaying its uptake to more downstream in the gut. The feed composition of the invention may be used for livestock animals such as ruminants, swine and poultry; and for pets such as cats and dogs. The skilled person will appreciate that feed composition will differ in composition depending on the animal.

The invention further pertains to an agrochemical composition comprising an oil-in-water emulsion comprising an oil comprising an agrochemical active ingredient; and optionally a solvent for dissolving the agrochemical active ingredient; water; and an emulsifier comprising acacia gum and the polysaccharide thickener, preferably xanthan gum, to form oil droplets of the oil, wherein the amount of the agrochemical active ingredient is from 0.001 to 1 wt %, based on the total weight of the agrochemical composition, wherein the d50 value of the oil droplet comprising the agrochemical active ingredient is at most 2 μm, preferably 1 μm. The oil-in-water emulsion may have the same embodiments as described above. The agrochemical composition may further comprise agrochemical excipients that are generally used in agrochemical compositions such as nutrients and minerals or excipients capable of improving the uptake of the agrochemical active ingredient or delaying its uptake or its use by the plant.

In yet a further embodiment, the invention pertains to a powder obtained by drying the oil-in-water emulsion of the invention, wherein the amount of water is at most 10 wt %, based on the total weight of the powder. The oil-in-water emulsions can be dried using conventional techniques to obtain a dry powder. Examples of suitable techniques include spray drying, fluidized bed drying and freeze drying. The obtained powder can be re-dispersed to form the oil-in-water emulsion of the invention. The oil droplets typically comprise the oil comprising the active ingredient and the emulsifier comprising acacia gum and a polysaccharide thickener, preferably xanthan gum.

The powder of the invention may comprise the oil droplets in an amount of at most 50% by weight (wt %), based on the total weight of the powder. Preferably, the oil droplets are present in an amount of at most 40 wt %, more preferably at most 35 wt %, even more preferably at most 30 wt % and most preferably at most 25 wt %, and preferably at least 1 wt %, more preferably at least 2 wt %, even more preferably at least 5 wt % and most preferably at least 10 wt %, based on the total weight of the powder.

The powder of the invention may comprise water in an amount of at most 10% by weight (wt %), based on the total weight of the powder. Preferably, water is present in an amount of at most 5 wt %, more preferably at most 3 wt %, even more preferably at most 2 wt % and most preferably at most 1 wt %, and preferably at least 0.001 wt %, more preferably at least 0.01 wt %, even more preferably at least 0.05 wt % and most preferably at least 0.1 wt %, based on the total weight of the powder.

In one embodiment of the invention, the powder further comprises a carrier material. Preferably, the emulsified oil droplets of the powder are deposited on the carrier material. The carrier material can be any carrier material suitable for supporting the dried oil droplets of the emulsion of the invention. Examples of suitable carrier materials include inorganic carriers such as silica, alumina, hydrotalcite and bentonite; and organic carriers such as powders derived from wheat, beet, soy, maize and potato.

The powder of the invention may comprise the carrier material in an amount of at most 95% by weight (wt %), based on the total weight of the powder. Preferably, the carrier material is present in an amount of at most 90 wt %, more preferably at most 85 wt %, even more preferably at most 80 wt % and most preferably at most 75 wt %, and preferably at least 1 wt %, more preferably at least 2 wt %, even more preferably at least 5 wt % even more preferably at most 10 wt % and most preferably at least 20 wt %, based on the total weight of the powder.

The invention is exemplified in the following Examples.

### EXAMPLES

### Example 1

An emulsion according to the invention was obtained by emulsifying a mixture of 0.35 wt % xanthan gum, 3.65 wt % acacia gum, 9 wt % propylene glycol, 16 wt % eucalyptol, 10 wt % polysorbate 80 and 61 wt % purified water using high shear.

Particle Size Distribution

The particle size distribution was determined using dynamic light scattering. The resulting emulsion has oil droplets with a d90 value of 215 nm, and a monomodal particle size distribution.

The emulsion was stored at room temperature for 6 months. The d90 value of the oil droplets after 6 months was 197 nm with a monomodal particle size distribution. The particle size did not significantly change after 6 months storage, demonstrating that the emulsion was stable.

Rheology

The rheology of the emulsions of the invention was determined at 20° C. using an Anton Paar MCR301 rheometer. The shear rate was increased from 0.01 s⁻¹ to 1000 s⁻¹. The emulsions of Example 1 both exhibit shear thinning behaviour, i.e. the viscosity decreases upon increasing shear rate. The viscosity at a shear of 0.01 s⁻¹ for the fresh sample was about 70 Pa·s, and the viscosity of the emulsion after 6 months of storage was about 8 Pa·s. For both emulsions the viscosity at high shear (i.e. 1000 s⁻¹) was below 100 mPa·s.

It is noted that a solution of xanthan gum in water also exhibits a similar shear thinning behaviour. As indicated above, the viscosity of the fresh emulsion at low shear is significantly higher than the viscosity of the emulsions stored for 6 months. It is contemplated that the lower viscosity in the emulsion stored for 6 months is due to xanthan gum dissolved in the water phase being transferred to the oil-water interface and recombines with the acacia gum emulsifier present at the oil-water interface. This leads to a lower concentration of xanthan gum in the water phase and consequently leads to a lower viscosity of the emulsion at low shear.

1. An oil-in-water emulsion comprising:
an oil comprising an active ingredient;
water; and
an emulsifier comprising acacia gum and a polysaccharide thickener to form oil droplets of the oil;
wherein the d50 value of the oil droplets is at most 2 μm.

2. The emulsion according to claim 1, wherein the active ingredient is a feed additive ingredient.

3. The emulsion according to claim 2, wherein the feed additive ingredient is an essential oil.

4. The emulsion according to claim 1, wherein the active ingredient is an agrochemical active ingredient.

5. The emulsion according to claim 4, wherein the agrochemical active ingredient is selected from the group consisting of insecticides, herbicides and fungicides.

6. The emulsion according to claim 1, wherein the weight ratio between water and the active ingredient is at least 1.

7. The emulsion according to claim 1, wherein the polysaccharide thickener is selected from the group consisting of xanthan gum and guar gum.

8. The emulsion according to claim 7, wherein the polysaccharide thickener is xanthan gum.

9. The emulsion according to claim 1, wherein the weight ratio between acacia gum and the polysaccharide thickener is at least 5.

10. The emulsion according to claim 1, wherein the d50 value of the oil droplets is at most 1 μm.

11. A feed composition comprising:
the oil-in-water emulsion of claim 1;
wherein the active ingredient is a feed additive ingredient;
wherein the amount of the feed additive ingredient is from 0.001 to 1 wt %, based on the total weight of the feed composition; and
wherein the d50 value of the oil droplets comprising the feed additive ingredient is at most 2 μm.

12. An agrochemical composition comprising:
the oil-in-water emulsion of claim 1;
wherein the active ingredient is an agrochemical active ingredient;
wherein the amount of the agrochemical active ingredient is from 0.001 to 1 wt %, based on the total weight of the agrochemical composition; and
wherein the d50 value of the oil droplets comprising the agrochemical active ingredient is at most 2 μm.

13. A powder obtained by drying the oil-in-water emulsion of claim 1, wherein the amount of water is at most 10 wt %, based on the total weight of the powder.

14. The powder according to claim 13 further comprising:
a carrier material;
wherein the emulsified oil droplets are deposited on the carrier material.

15. The emulsion according to claim 1 further comprising:
a solvent for dissolving the active ingredient

16. The emulsion according to claim 1, wherein the active ingredient is selected from the group consisting of a feed additive ingredient and an agrochemical active ingredient;
wherein the polysaccharide thickener is selected from the group consisting of xanthan gum and guar gum;
wherein the d50 value of the oil droplets is at most 1 μm; and
wherein the weight ratio between water and the active ingredient is at least 100.

17. The emulsion according to claim 16, wherein the feed additive ingredient is an essential oil; and
wherein the agrochemical active ingredient is selected from the group consisting of insecticides, herbicides and fungicides.

18. The emulsion according to claim 16, wherein the weight ratio between acacia gum and the polysaccharide thickener is at least 10.
